(19) United States
(12) Patent Application Publication
(10) Pub. No.: US 2017/0055458 A1
(43) Pub. Date: Mar. 2, 2017

(54) LANDSCAPING TOOL

(71) Applicant: Partners In Innovation Limited, LLC, Cincinnati, OH (US)

(72) Inventors: John A. Helmsderfer, Cincinnati, OH (US); Robert E. Borgmann, Maineville, OH (US)

(21) Appl. No.: 15/250,432

(22) Filed: Aug. 29, 2016

Related U.S. Application Data
(60) Provisional application No. 62/211,382, filed on Aug. 28, 2015.

(51) Int. Cl. A01G 3/025; A01G 3/08

(52) U.S. Cl. CPC A01G 3/0251; A01G 3/083

(57) ABSTRACT

A tool capable of functioning in a first configuration as one type of cutter or pruner and in a second configuration as another type of cutter or pruner has functions to increase the comfort and efficiency of the cutting process. In some embodiments, a pruning saw assembly may be employed with the cutter mechanism for versatility.

### CROSS-REFERENCE TO RELATED APPLICATIONS

This application claims the benefit of U.S. Provisional Patent Application Ser. No. 62/211,382, filed Aug. 28, 2015, the disclosure of which is expressly incorporated by reference herein in its entirety.

### FIELD OF THE INVENTION

This invention relates to tools for landscaping and particularly to handheld tools for cutting and pruning, such as pruners, pull saws or lopping shears, that are used to trim plants, trees and other natural growth.

### BACKGROUND OF THE INVENTION

Gardeners and landscapers, both professional and recreational, often desire to prune the limbs of both live and dead ornamental landscape plantings. The process of pruning and/or trimming a tree or plant involves cutting of plants or limbs of varying diameter and density, to achieve a desirable shape. The larger and more robust limbs are often cut using a bypass style cutter, often referred to as loppers, which the smaller more delicate branches are trimmed using a handheld pruner. Alternatively, some pruning practices suggests that plant health is optimized and cutting effort is reduced by using anvil style pruners to cut dead and dry wood. Whereas, the bypass or scissor style pruners are best suited for cutting live plant wood growth. In any use, because of the various pruning scenarios, the task requires the purchase and use of multiple devices and it requires the operator to find and switch pruning devices throughout the process.

Still further, while a lopper style cutter or bypass style cutter might be suitable for branches or cuttings of a certain diameter, there will still often be plants that are too large to prune using such tools. Oftentimes, saws are used for pruning thicker branches. This results in a further additional tool that must be purchased, maintained and carried by a landscaper or other person to the job sight work area. Also saws are often handheld versions that require a ladder for an extended or elevated use.

As such, it is an objective of this invention to make the pruning process more convenient and time efficient by reducing the number of tools that have to be used during a pruning, trimming or landscaping process. It is another objective to reduce the number of tools that are necessary for purchase, transport and storage in order to handle multiple landscaping tasks. Still further, it is an objective to provide a tool that is comfortable and easy to use and configure. These and other objectives are addressed by the embodiments of the present invention.

### SUMMARY OF THE INVENTION

A landscaping tool in accordance with features of the invention may be selectively utilized as different types of cutters. The tool may be configured and reconfigured into the separate types of cutters as desired. In one embodiment, a set of bypass type cutters is in combination with a set of anvil type cutters. The cutter mechanisms implement features to reduce the distance that the handles of the tool have to travel to capture a branch and the distance that they have to travel toward each other to provide a cutting function.

In accordance with another feature of the invention, the landscape tool of the invention may have a pruning saw assembly incorporated with the cutter mechanisms of the tool. In that way, in addition to pruning with a cutter, a pruning saw may be implemented. In one embodiment, the saw is a separate element. In another, the handles of the tool are reconfigured for forming and deploying an extended pool saw with the pruning saw at the end of the tool.

### BRIEF DESCRIPTION OF THE DRAWINGS

FIG. 1 is a perspective view of one embodiment of a landscaping tool of the invention.

FIG. 1A is a perspective view, in partial cross-section, of the embodiment of the landscaping tool of FIG. 1.

FIG. 1B is a disassembled perspective view of the embodiment of the landscaping tool of FIG. 1.

FIG. 2 is a side view, in partial cross-section, of the embodiment of the landscaping tool of FIG. 1.

FIG. 3 is another side view, in partial cross-section, of the embodiment of the landscaping tool of FIG. 1.

FIG. 4 is another side view, in partial cross-section, of the embodiment of the landscaping tool of FIG. 1.

FIG. 5 is another side view, in partial cross-section, of the embodiment of the landscaping tool of FIG. 1 showing a transition between an anvil style cutter and a bypass style cutter.

FIG. 6 is another side view, in partial cross-section, of the embodiment of the landscaping tool of FIG. 1 shown as a bypass style cutter.

FIG. 7 is a perspective view of another embodiment of a landscaping tool of the invention.

FIG. 8 is a perspective view, in partial cross-section, of the embodiment of the landscaping tool of FIG. 7.

FIG. 9 is a disassembled perspective view of the embodiment of the landscaping tool of FIG. 7.

FIG. 10A is a side view, in partial cross-section, of the embodiment of the landscaping tool of FIG. 7.

FIG. 10B is another side view, in partial cross-section, of the embodiment of the landscaping tool of FIG. 7.

FIG. 11 is another side view, in partial cross-section, of the embodiment of the landscaping tool of FIG. 7.

FIG. 12 is another side view, in partial cross-section, of the embodiment of the landscaping tool of FIG. 7 showing a transition between an anvil style cutter and a bypass style cutter.

FIG. 13 is another side view, in partial cross-section, of the embodiment of the landscaping tool of FIG. 7 shown as a bypass style cutter.

FIG. 14 is a perspective view of one embodiment of a landscaping tool of the invention.

FIG. 15 is a side view, in partial cross-section, of the embodiment of the landscaping tool of FIG. 14.

FIG. 15A is a partially disassembled perspective view of the embodiment of the landscaping tool of FIG. 14.

FIG. 15B is a another partially disassembled perspective view of the embodiment of the landscaping tool of FIG. 14.

FIG. 16 is another perspective view of the embodiment of the landscaping tool FIG. 14.

FIG. 17 is a partial perspective view of the embodiment of the landscaping tool of FIG. 14 shown implementing a pruning saw assembly.

FIG. 18 is a perspective view of a pruning saw assembly from the embodiment of the landscaping tool of FIG. 14.

FIG. 19 is a side view of the pruning saw assembly of FIG. 18.

FIG. 20 is a perspective view of another embodiment of a landscaping tool of the invention.

FIG. 21 is another perspective view of the embodiment of the landscaping tool of FIG. 20.

FIG. 22 is a perspective view of a pruning saw assembly from the embodiment of the landscaping tool of FIG. 20.

FIG. 23 is a perspective view of a pruning saw assembly from the embodiment of the landscaping tool of FIG. 20.

FIG. 24 is another perspective view of the embodiment of the landscaping tool of FIG. 20 configured as a pole saw.

FIG. 25 is another perspective view, in partial cross-section, of the embodiment of the landscaping tool of FIG. 20.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

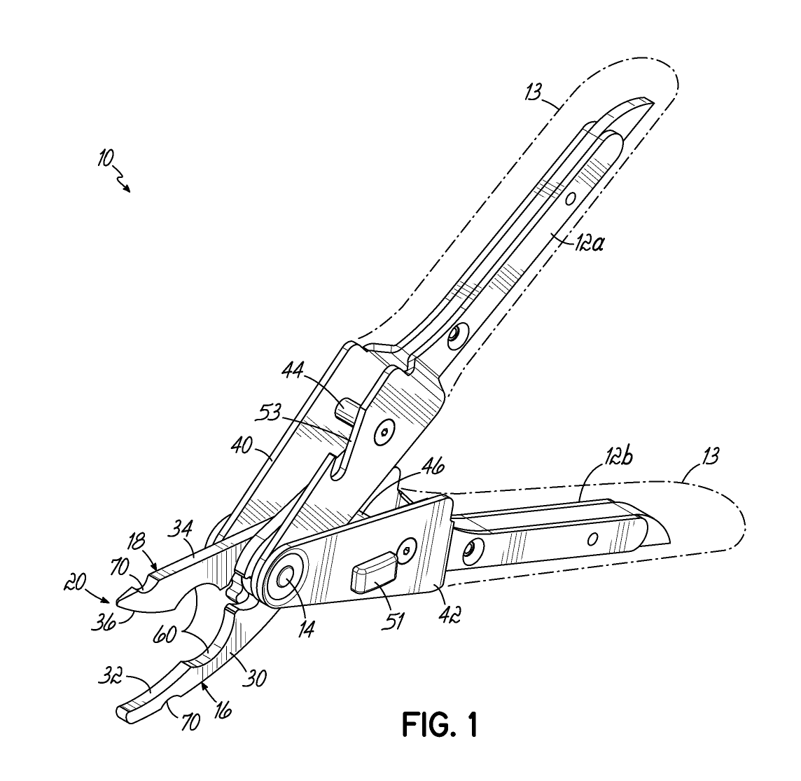

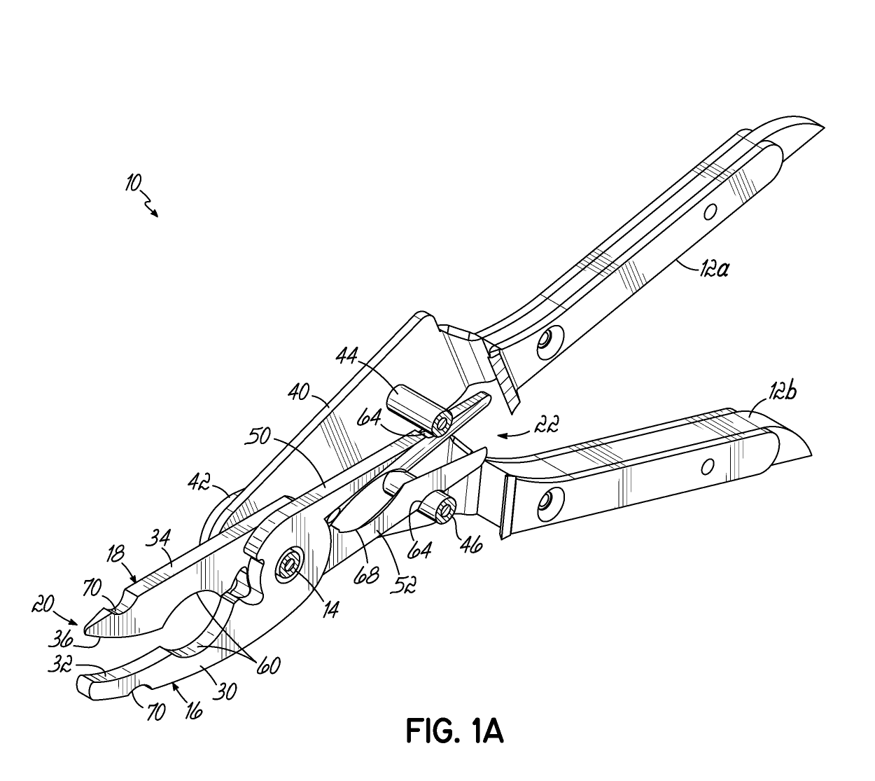

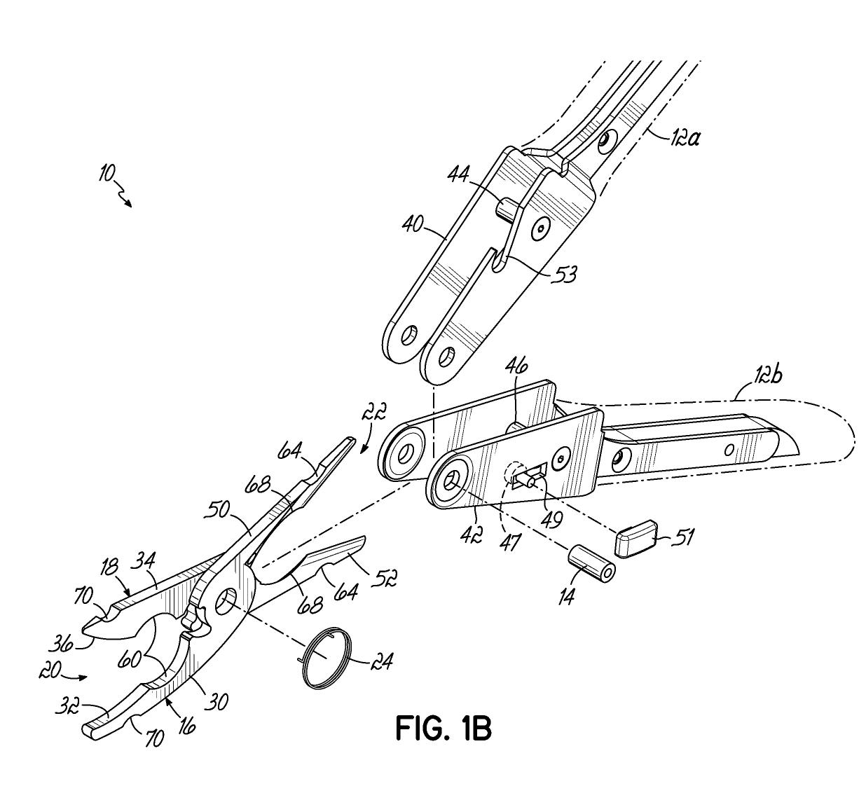

FIG. 1 is a perspective view of a landscaping tool in accordance with features of the present invention. The landscaping tool embodiment 10 provides features of both an anvil style pruner or cutter and a bypass style pruner or cutter. The type of cutter may be selected by a user when needed and the tool can be readily and easily configured as desired. Handles of the tool 10 may be rotated around a center axis for choosing which style of cutter is to be used.

More specifically, as illustrated in FIG. 1, the tool 10 includes opposing handles 12a,12a that are arranged to pivot about a center shaft 14 and provide a cutting force for the tool. Each of the handles 12a,12b may be rotated around the center shaft 14 for selection of the particular style cutter blades that are to be utilized. The handles may be covered with a suitable plastic or foam 13 for comfort. To that end, as illustrated in FIG. 1A, tool 10 includes opposing blade elements 16 and 18 that are mounted side by side and also configured to pivot or rotate around the center shaft 14. A portion of the blade elements 16,18 each form one-half of a particular cutter. That is, the end 20 of blade element 16 forms one portion of an anvil style cutter while the other end 22 forms one portion of a bypass style cutter. Similarly, blade element 18, at the forward end, provides a portion of the anvil style cutter while the rear end provides the other portion of the bypass style cutter. (see FIG. 1B). The various handles, blade elements and other elements as described herein are formed of a suitable material such as a metal that provides the strength and cutting edges and surfaces of the tool.

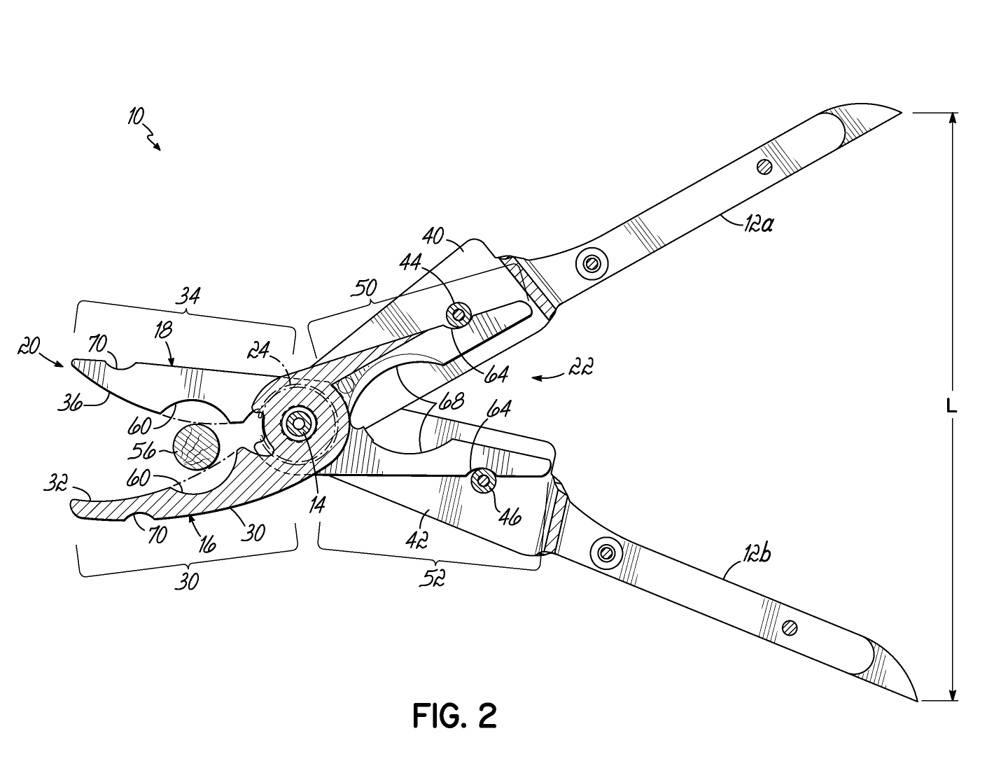

More particularly, as illustrated in FIGS. 2-4, the blade elements 16 and 18 are coupled together by the center shaft 14 and are configured to rotate together about the center shaft. A spring device 24 is incorporated with the blade elements 16-18 and around the center shaft 14 and in a conventional manner operates on the blade elements to bias both the bypass style cutter and anvil style cutter to an open position as illustrated in FIGS. 1-2, for example. As discussed further herein, the various handles 12a, 12b will act on the sections of the blade elements that extend at the rear end 22 to engage the various handles, in order to close the blade elements with a cutting force.

Turning to FIGS. 2-4, blade element 16 includes an anvil section 30 that provides an anvil surface 32. Blade element 18 provides an anvil blade section 34 with an edge 36 that bears against anvil surface 32, such as for cutting a branch or plant growth. That is, when handles 12a,12b are squeezed together, the anvil blade section 34 is brought against anvil section 30 so that edge 36 bears on surface 32 to provide a cut. To provide the cutting force, the handles 12a,12b couple with blade guards 40, 42 that capture the portions of the blade elements 16 and 18 at the rear end 22 of those blade elements as illustrated in FIG. 2. As shown in FIG. 1, there are a pair of blade guards 40, 42 associated with each of the handles 12a,12b. As such, there are blade guards on each side of tool 10. The distance separating each of blade guards 40,42 from the other corresponding blade guards in the pair will vary such that the blade guards 40 for handle 12a fit inside the blade guards 42 of handle 12b, so as to allow a scissor action of the tool. The blade guards have appropriate openings for the passage of center shaft 14 such that the blade guards and handles, as well as the blade elements 16 and 18 pivot around the center shaft 14. In one embodiment of the invention, the handles and blade guards are not coupled with the spring 24 acting on the blade elements and therefore are free to rotate around the center shaft 14. The center shaft might be held in place and the assembly held together by an appropriate threaded bolt/nut configuration, for example, or other suitable attachment mechanism.

To operate the tool 10 such that closing the handles 12a,12b will close sections of the blade elements 16,18, blade stop elements extend between the blade guards. The blade stop elements may be held between the blade guards again by an appropriate threaded bolt/nut configuration or some other configuration for maintaining their position between the blade guards for engaging the blade elements 16,18 at the rear end 22. Referring to FIG. 1A, blade guards are cut away on one side of the handles 12a,12b for illustrating the blade stop elements 44 associated with handle 12a and 46 associated with handle 12b. In accordance with one embodiment as illustrated, the blade stop elements may be cylindrically shaped elements configured to bear against the blade elements 16,18 as discussed herein.

Referring to FIG. 2, the bypass style cutter consists of two bypass blade sections 50,52. The bypass blade elements are configured to bypass each other and form a scissors action to cut. Bypass blade section 50 is a part of blade element 16 and forms a unitary blade element along with anvil section 30. Similarly, bypass blade section 52 is part of blade element 18 and forms a unitary blade element along with the anvil blade section 34. Accordingly, the anvil style cutter and the bypass style cutter operate in conjunction such that action on one such cutter by the handles is translated to the other cutter.

More specifically, referring to FIG. 2, tool 10 is illustrated to be configured as an anvil style cutter. That is, the anvil section 30 and anvil blade section 34 are positioned at the front of the tool for use. The scissor style cutter and bypass blade sections 50 and 52 are positioned rearwardly and generally in contact with the blade stop elements 44 and 46 as shown. When the handles 12a,12b are opened or spread apart to a maximum length L as shown in FIG. 2, the blade stop elements 44,46 do not significantly bear upon the bypass blade sections. As such, the anvil style cutter is open to receive an element to cut, such as a branch 56 or other growth.

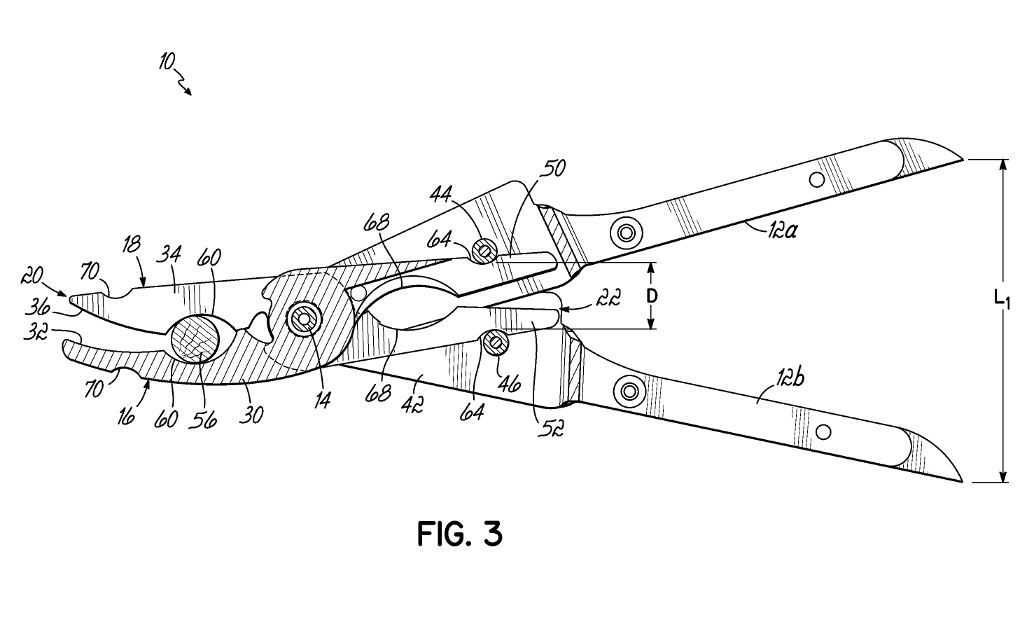

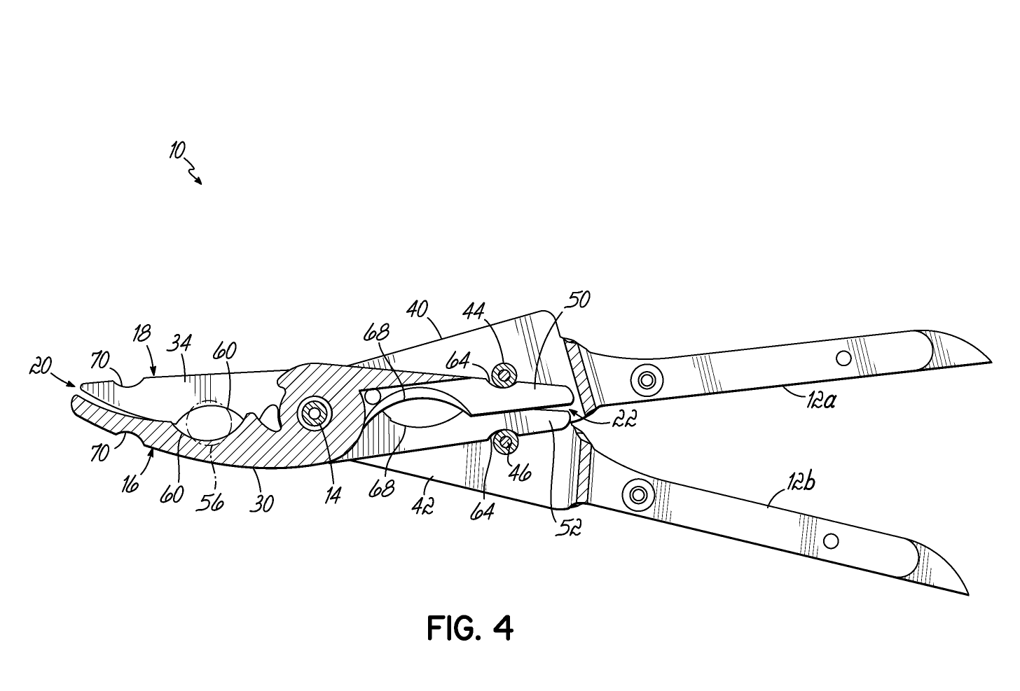

In accordance with one aspect of the invention, the respective anvil style cutters and bypass style cutters have notches formed therein, both internally along an inner edge in the respective anvil section 30 or anvil blade section 34 and also on externally along an outer edge. Such notches limit the length L that must be utilized in order to open the various cutters for receiving a branch 56. Specifically, shown in FIGS. 2-4, the anvil section 30 and anvil blade section 34 each include respective internal notches 60 that are formed in respective surface 32 and edge 36. That is, for the length of the anvil section and anvil blade section, the respective surface 32 and edge 36 are not carried along in a continuous radius for the length of the sections 30,34. Rather, the internal notches 60 are formed to receive the branch 56. In that way, the branch may be received between the anvil section and anvil blade section for cutting purposes and may be positioned rearwardly in the anvil style cutter so that a cutting force may be applied with a significantly reduced distance L₁ at the end of the handles 12a,12b. As seen in FIG. 2, with dashed lines along the surface and edge 32, 36, a certain handle spread L would be necessary for engaging branch 56, also the handles would then have to move together for a certain distance to effect the cut. Referring to FIG. 3, the notches 60 ensure that the branch 56 may be engaged by the respective surface 32 and edge 36 with the handles closer together than could be achieved with the traditional curved anvil section 30 and blade section 34. Therefore the distance that the handles have to move toward each other to provide the desired cutting function for the tool is reduced. As a result, a greater amount of squeezing or gripping force may be applied to the handles 12a,12b for the purposes of cutting branch 56. As may be appreciated, the gripping strength and therefore cutting strength of a hand is reduced the further the palm and fingers and thumb have to be spread out to apply a force to the handles. Also, the cutting stroke of bringing the handles together for the cutting function is reduced. Thus, the present invention ensures that maximum force may be applied over the shorter distance L₁ for proper cutting as shown in FIG. 4.

In accordance with another aspect of the invention, to further reduce the distance L that the handles 12a,12b must be spread apart and then brought back together again to capture and cut branch 56 and to further reduce the handle distance L₁ for effective cutting and the amount of travel for the cutting function, external notches are used in the opposing bypass blade sections 50,52. Referring to FIG. 3, external notches 64 are formed in respective bypass blade sections 50,52 at the position wherein the blade stop elements 44,46 would engage the blade sections 50,52 for operating the anvil style cutter. As such, the distances L and L₁ are again reduced to provide easier use of the tool 10 and a greater cutting force applied to either the anvil style cutter or bypass style cutter in use. The notches 64, and their respective depths, may be adjusted as desired depending on the dimension of the blade elements 16, 18. As shown in FIGS. 2-4, the notches 64 allow the bypass blade sections 50,52 to be engaged at a reduced distance D than the distance that may be required if the stop element acted on the blade elements without the notches 64 of the invention. This also reduces the amount of the distance that the handles have to travel or move toward each other to provide the desired cutting function. Accordingly, the combination of internal notches 60 on the actual cutter, as well as external notches 64 on the opposing blade sections that are acted upon by the handle through the stop elements, provides more comfortable use of the tool, as well as a greater cutting force applied by the tool when the handles 12a,12b are gripped or squeezed.

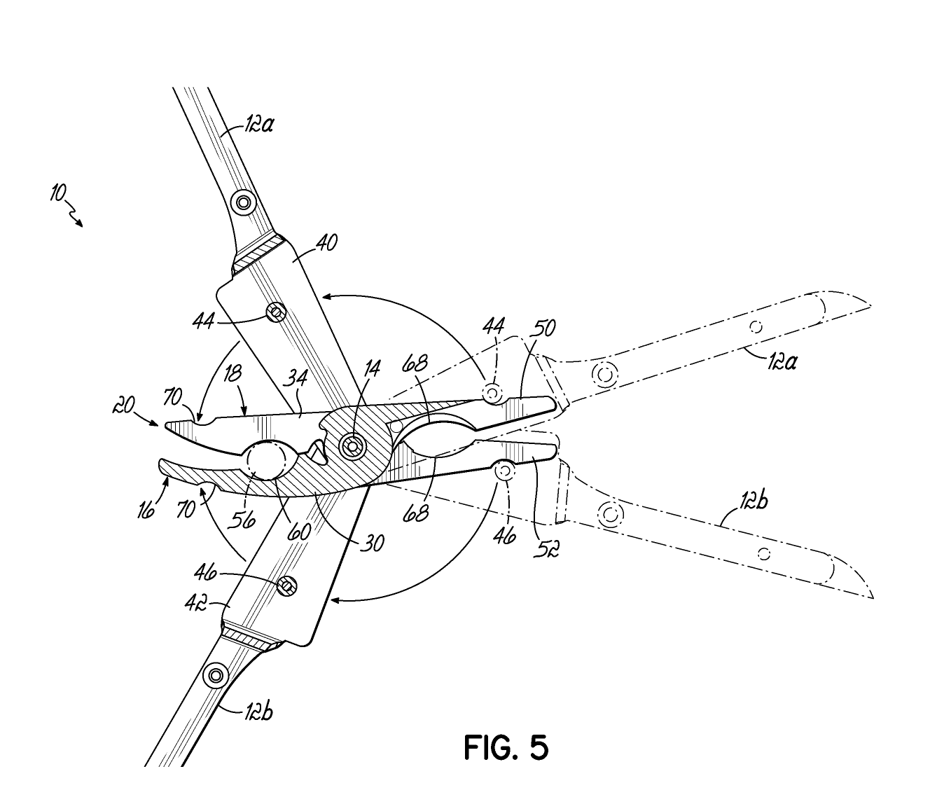

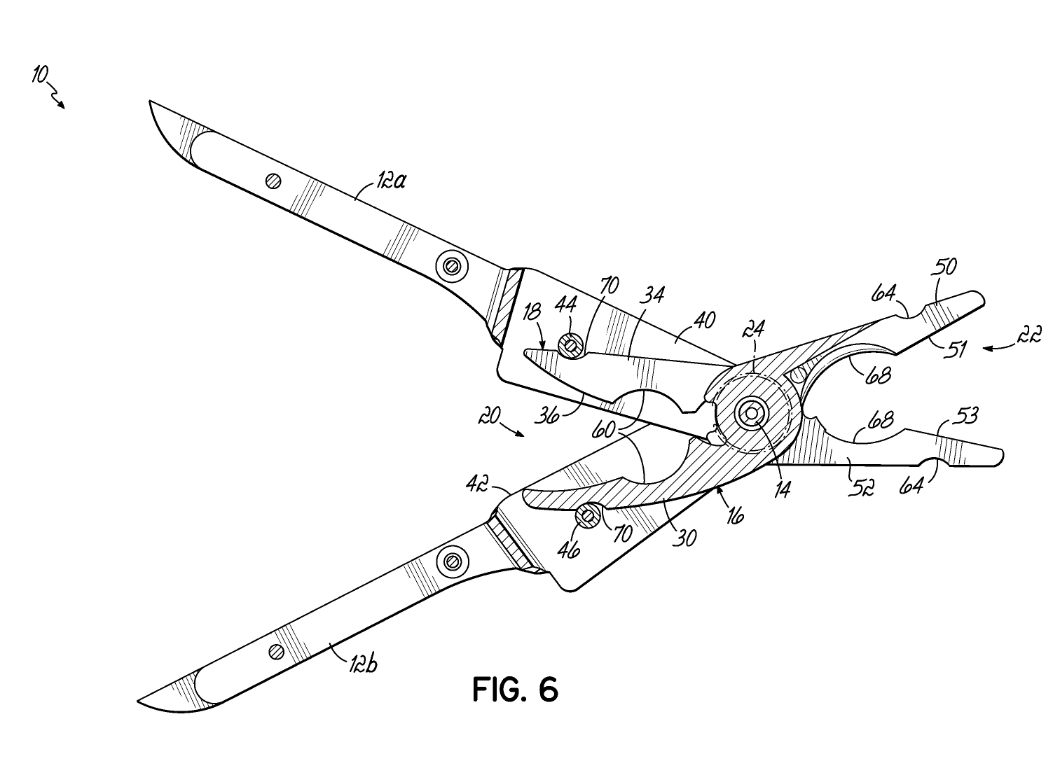

In accordance with another aspect of the invention, the tool 10 may be readily changed from an anvil style cutter to a bypass style cutter through rotation of the handles 12a,12b about the center shaft 14. As noted, while the blade elements 16,18 are spring-loaded to be biased apart at the cutting ends, the handles 12a,12b are free to rotate about the center shaft 14. As illustrated in FIG. 5, the handles may be rotated such that the blade guards 40,42 overlie or capture the sections of the blade elements 16,18 proximate end 20. That is, the blade guards 40,42 overlie and capture the anvil section 30 and the anvil blade section 34 as seen, for example, in FIG. 6. As such, the tool 10 may then be used as a bypass style cutter with bypass blade sections 50,52 open to engage a branch 56. The bypass blade sections 50,52 also include internal notches 68 that are formed in the sharpened edges 51,53 of the bypass blade sections 50,52. As may be appreciated, the edges 36 and 51,53 may be sharpened to provide for ease of cutting. Surface 32 of the anvil section 30 will generally be more blunt as the sharpened edge 36 bears against surface 32. Similarly, the respective notches 60,68 are also appropriately sharpened or angled, for example, as illustrated in FIG. 6, for ease of cutting. Internal notches 68 provide for a reduced handle opening or spread distance L as discussed hereinabove with respect to FIGS. 1-5. In that way, a branch might be engaged and moved to the back of the blade sections 50,52 while allowing a shortened gripping distance L₁ for greater cutting force to be applied by a user squeezing the handles 12a,12b.

In accordance with another feature, the sections of the anvil style cutter, including anvil section 30 and anvil blade section 34 also include external notches 70 formed in the external or outward edges of the respective sections 30,34. The notches 70 are positioned and configured to engage the blade stop elements 44,46 in order to bear down against the spring biased blade elements and close the bypass blade sections 50 against each other for cutting branches and other growth. When the handles are rotated around, the stop elements engage the notches 70. That is, the tool and the configuration shown in FIG. 6 operates in a similar fashion to the tool as illustrated in FIGS. 1-4 and thus can provide the benefits of the invention in both an anvil style cutter and bypass style cutter in a single tool 10. The features as disclosed herein provide a greater ease of use, since a person's hand does not have to spread apart so significantly for engaging a branch or other growth and also provides an improved gripping scenario for application of a greater gripping force when a branch or other growth is to be cut in either configuration of tool 10. That is, the internal notches in the various blade elements 16,18 allow a branch to be engaged with a smaller spread of the handles 12a,12b. Similarly, the external notches reduce the handle spread length. When force is applied, the cooperation of the internal and external notches also provides for a reduced handle spread and the application of a greater cutting force by the hand of the user.

The tool 10 also includes a latch for keeping the tool in a closed position, such as for storage. To that end, a slidable latch 47, slides in an appropriately configured slot 49 in one of the blade guards. A finger piece 51 is engaged to slide the latch 47. When the handles 12a, 12b are brought together, the latch 47 may be slid into an appropriately configured notch 53 in another of the blade guards. As may be appreciated, if the notch 53 is only on one side, the tool may have to be in an appropriate configuration (bypass or anvil) in order to latch.

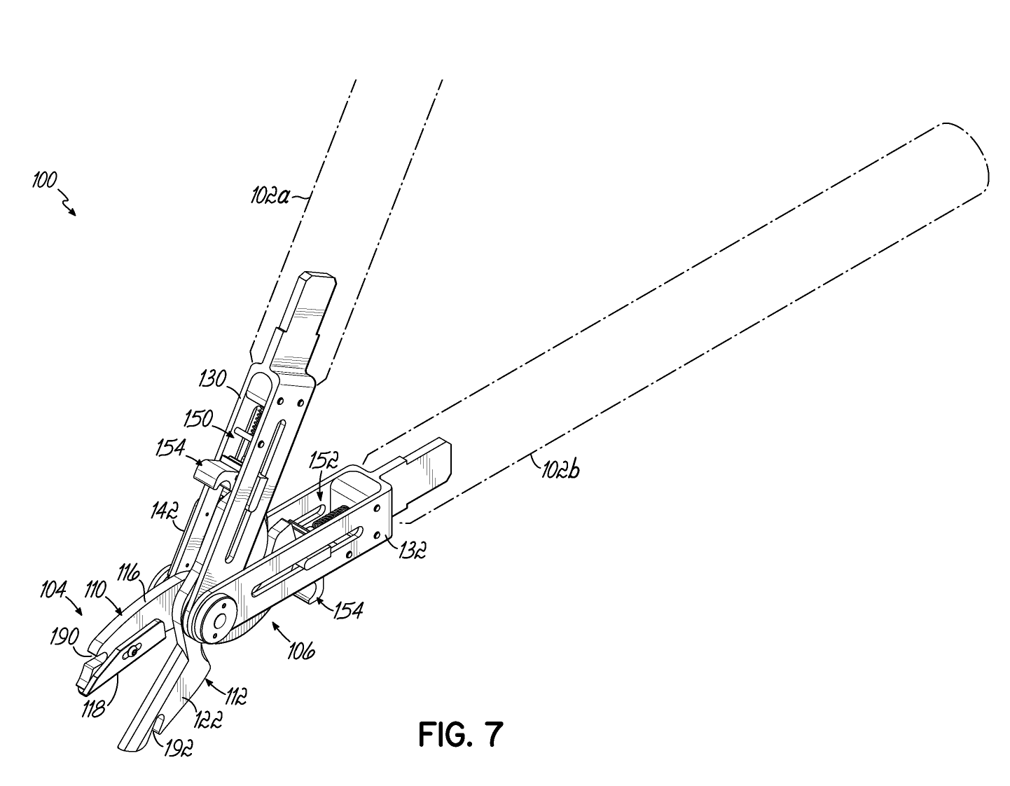

FIGS. 7-13 illustrate an alternative embodiment of the invention wherein a single tool provides both an anvil style cutter and a bypass style cutter based upon the selected configuration of a user. Referring to FIG. 7, tool 100 may be used to operate as both a bypass style cutter and an anvil style cutter similar to other embodiments as discussed herein. Tool 100 is incorporated as a two-handed tool with longer handles that provide more leverage and are brought together to provide a greater cutting force on a branch or growth. Tool 100, for example, may be used for thicker branches or tougher growth for which the handheld version of FIGS. 1-6 would not be appropriate. The embodiment as discussed with respect to FIGS. 7-13 may be used with basically elongated handles 102a,102b as illustrated in FIG. 7. Alternatively, as discussed further herein, tool 100 might incorporate other handles that have integral features therein, such as a pruning saw assembly, for further providing additional uses for the tool.

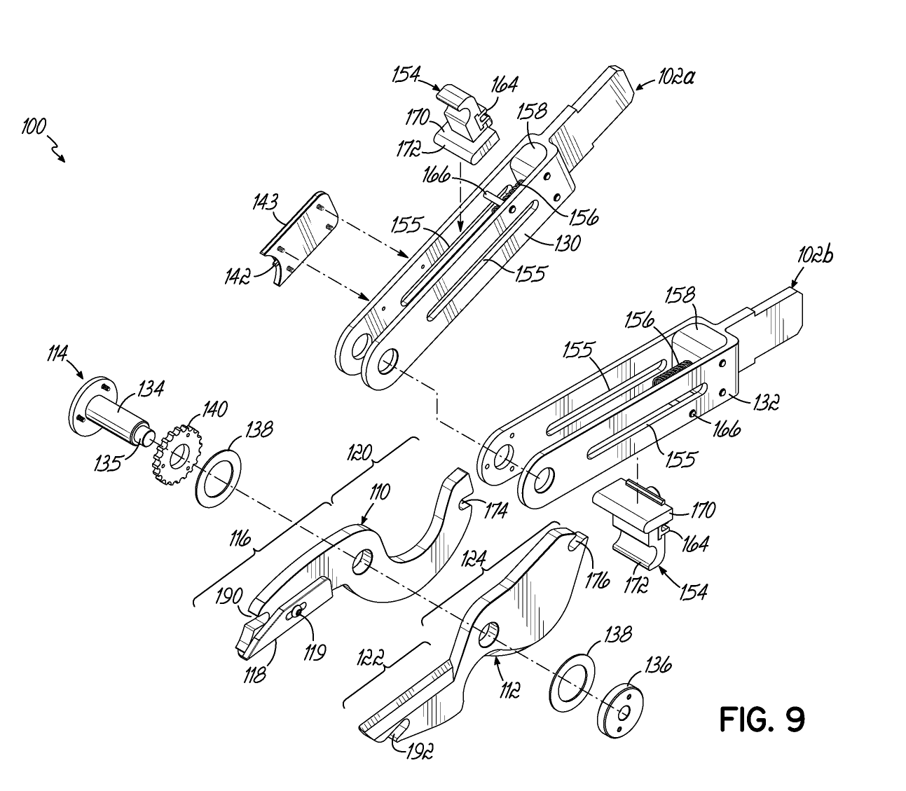

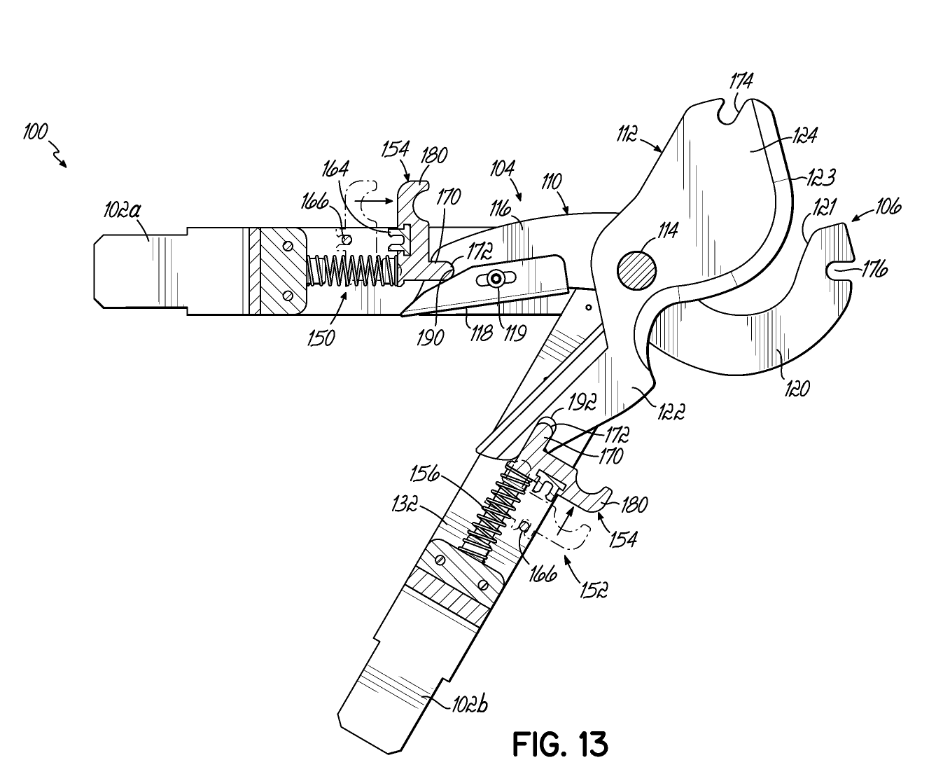

Turning to FIG. 7, tool 100 has an anvil type cutter head 104 that is positioned opposite a bypass style cutter head 106. Action on the bypass cutter head 106 of the handles 102a,102b is translated to the anvil cutter head 104 to provide a cutting action. Similarly, when the tool 100 has been configured to act as a bypass style cutter, the bypass cutter head 106 is exposed for cutting as illustrated in FIG. 13. In such a version, the bypass tool might often be referred to as a “lopping shear”. Referring to FIG. 9, tool 100 includes blade elements 110,112 which rotate about a center axis 114. Each of the blade elements provides one side of each of the anvil cutter head 104 and bypass cutter head 106. More particularly, as shown in FIG. 9, blade element 110 provides an anvil section 116 with an anvil surface 118. The anvil surface 118 may be integral with the blade element 110 or might be a separate piece as shown in the Figures that is attached by an appropriate bolt 119 or screw. The other side of blade element 110 is a bypass blade section 120. Similarly, blade element 112 provides an anvil blade section 122 and an opposing bypass blade section 124. The handles 102a,102b are coupled with appropriate blade guards 130,132 that include latching mechanisms therein for selecting the type of cutting head for the tool 100. Center axis 114 may include a bolt element 134 with a threaded end 135 that couples with a threaded nut element 136. Appropriate washers 138 might be utilized as well as a ratchet gear 140 that engages a tooth 142 that is coupled with blade guard 130, such as through a plate 143. The ratchet gear 140 bears against tooth 142 as the gear is rotated to provide a clicking sound used for audible feedback for a user.

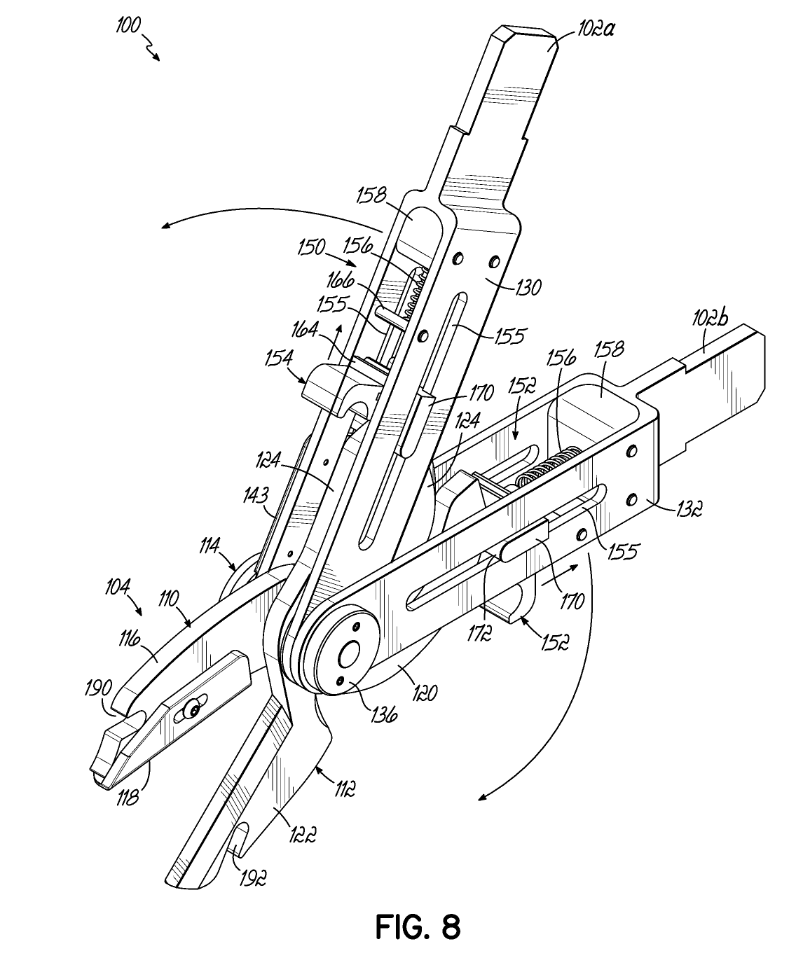

As illustrated in FIGS. 8 and 9, blade guard 130 is configured to be somewhat more narrow than blade guard 132 so as to nest within the blade guard 132 in use. The blade guards also support the latching mechanisms used for configuring tool 100 into a particular type of tool, such as an anvil type cutter or bypass type cutter or lopping shear. As illustrated, the blade guards 130,132 rotate with respect to each other along with the appropriate handle 102a, 102b.

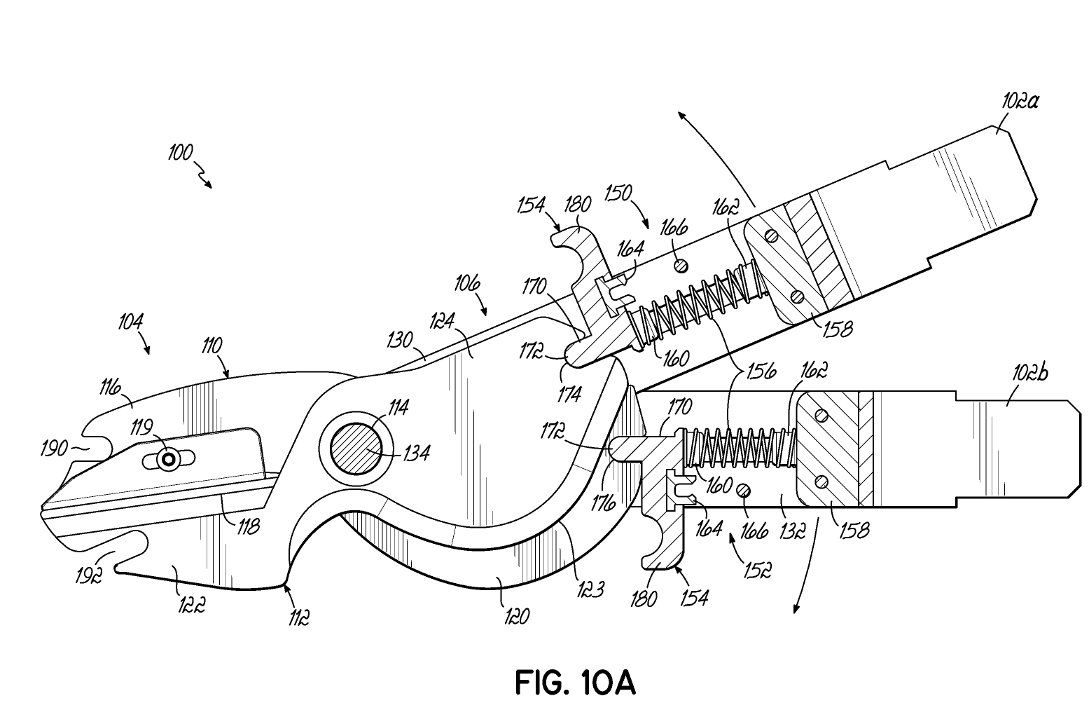

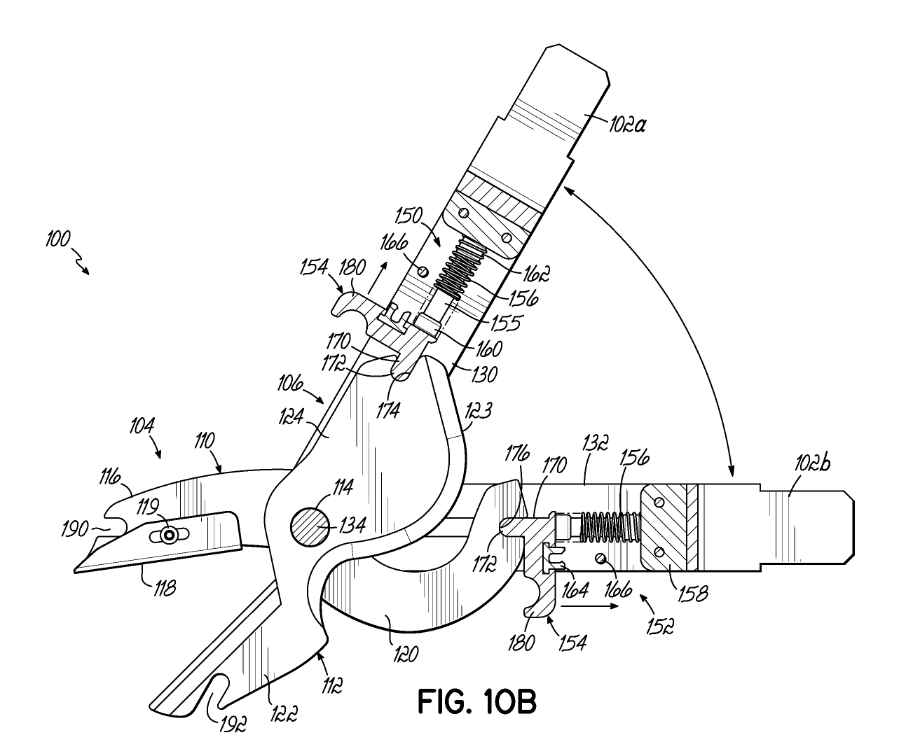

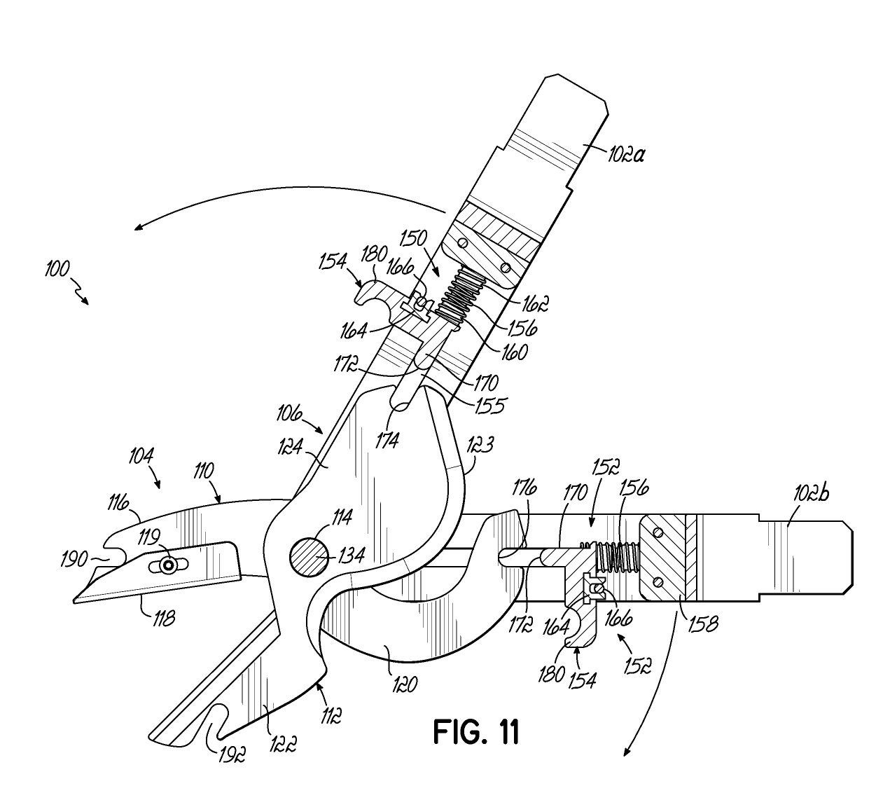

Referring to FIGS. 10A and 10B, the blade guards 130,132 that are coupled with handles 102a and 102b include latch mechanisms 150,152 for latching the unused sections of the blade elements and translating the force on the handles 102a,102b to the particular cutting head that is exposed. The latch mechanisms each include a sliding latch 154 coupled to bias springs 156 that are in turn coupled to a base element 158 in the respective blade guards. The springs 156 are held in alignment by post elements 160 on the latch and 162 on the base elements 158. Each of the latches also includes a lock structure 164 on the latches 154. The lock structure 164 engages an appropriate cross pin 166 that span between the opposing sides of the blade guards 130,132. Formed in each of the sides of the blade guards are slots 155 in which the latches 154 travel. Specifically, as illustrated in FIG. 9, each of the latches 154 includes slide section 170 that is configured to span between opposing sides of the blade guards and be captured on both sides so as to allow the latch to slide toward and away from the blade elements 110,112. The slide sections 170 also include a forward edge 172 that is configured to engage appropriately configured notches 174,176 for coupling each of the blade elements 110,112 with a respective handle 102a,102b. Each of the latches 154 also includes an engagement section 180 that may be manually engaged, such as by the hand or fingers of the user to pull the latches 154 along the tracks 155 formed in each of the blade guards 130,132. By gripping the latch 154 proximate to the engagement sections 180, the latches may be pulled rearwardly as illustrated by arrows in FIG. 10B and 11 to disengage a particular latch 154 and handle 102a,102b from a respective blade element 110,112.

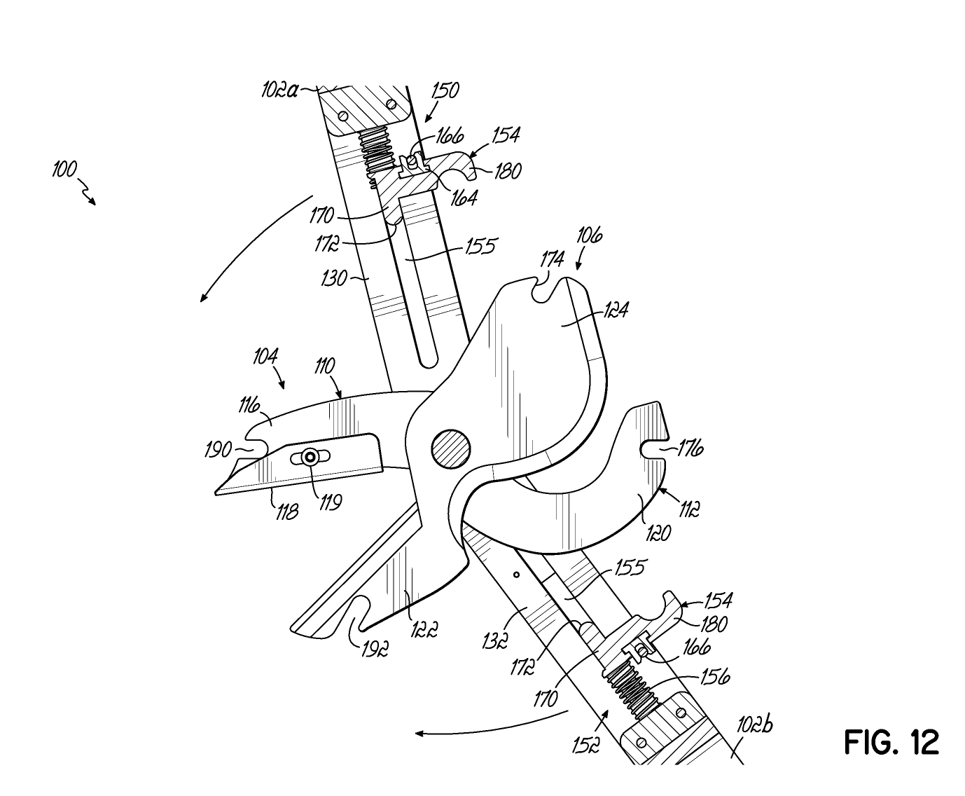

When in use, the latches 154 engage the respective notches 174,176 and thus lock the handles 102a,102b with the blade elements. However, to change between selectable cutting heads, the latches 154 are moved rearwardly to disengage from the blade elements and the blade elements may be rotated together about the center axis 114 so that a different cutting head is available for use. Referring specifically to FIGS. 10A-12, FIGS. 10A,10B illustrate the tool 100 of the invention with an anvil style cutter head 104 as the available cutter head. To switch the cutter head, as illustrated in FIG. 11, the latches are engaged at the engagement sections 180 and pulled rearwardly against the bias of the springs 156. The lock structures 164 of each of the latches 154 will engage the appropriate or respective cross pin. The lock structures 164 are configured or dimensioned to stay engaged with the cross pins 166 against the bias of the spring 156. Referring to FIG. 12, the blade elements 110,112 or the handles 102a, 102b are rotated with respect to each other so as to expose the other blade sections for use. With respect to FIGS. 12 and 13, the bypass blade sections 120,124 are exposed for providing the bypass cutter head 106 for usage. The bypass cutter head 106 or lopper shear is exposed while the anvil cutter head including anvil section 116 and anvil blade section 122 are contained in the blade guards 130,132 proximate to the handles.

As illustrated in FIG. 12, each of the anvil blade section 122 and anvil section 116 includes a respective notch 190,192 for engagement with the latch mechanisms 150,152. Specifically, as shown in FIG. 13, once the handles or the blade elements have been rotated with respect to the other for exposing a different cutter head, the latches 154 may be manually disengaged from a locked position, such as by pushing them forward as shown by the arrows in FIG. 13. The lock structures 164 then disengage from the cross pins 166 and the edges 172 of the latch slide sections then slide into the notches 190,192 to again lock the various blade elements 110,112 with the respective handles. Then, movement of the handles will cause movement of the various blade elements and thus cause a bypassing action of the bypass blade sections 120 and 124. One or more of the opposing edges 121,123 might be sharpened as illustrated in FIG. 12 for more efficient cutting. Similarly, the edge of the anvil blade section 122 might also be sharpened for improved cutting. In that way, tool 100 may have multiple purposes, including acting as both a bypass cutter or lopping shear and an anvil cutter, selectively.

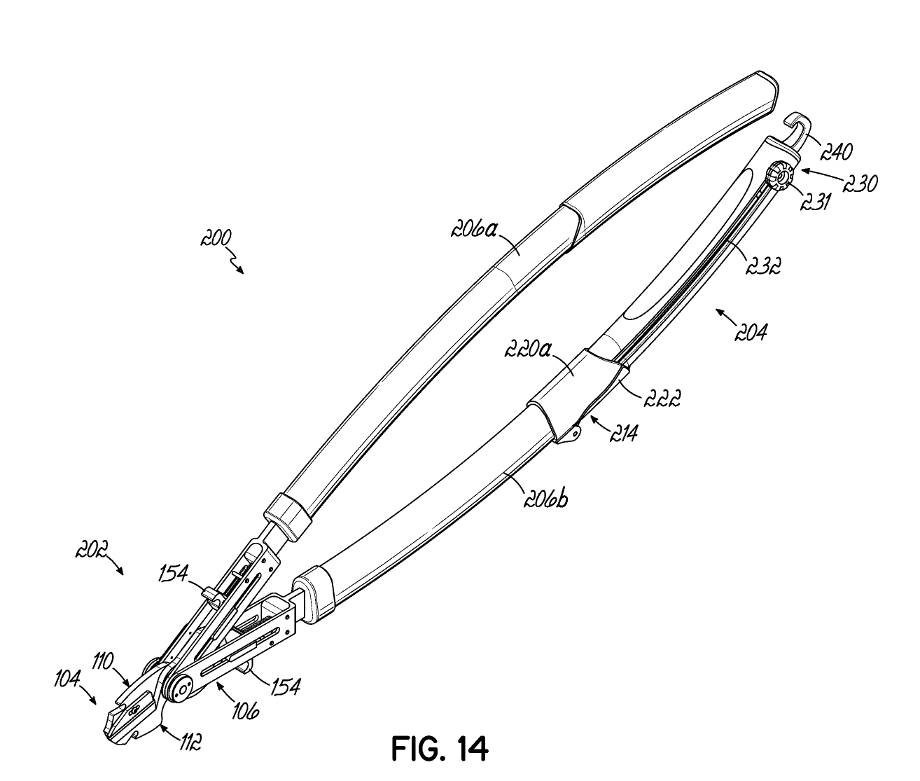

FIGS. 14-19 illustrate an alternative embodiment of the invention wherein a pruning saw is incorporated into a combination tool that includes a cutting or pruning head. The illustrated embodiment as shown in FIGS. 14-19 shows the use of handles that are used to drive or operate a cutting head, but also integrate a pruning saw assembly. The embodiment illustrated in FIGS. 14-19 are shown with a cutting/pruning head or mechanism that may be reconfigured between an anvil type cutter and a bypass type cutter. However, the embodiment as illustrated in FIGS. 14-19 that has an incorporated and integrated pruning saw assembly does not have to be utilized with a reconfigurable device as illustrated, but might be used simply with a dedicated cutting mechanism, such as a dedicated anvil type cutter or a dedicated bypass type cutter. Accordingly, the invention is not limited to the specific embodiment illustrated.

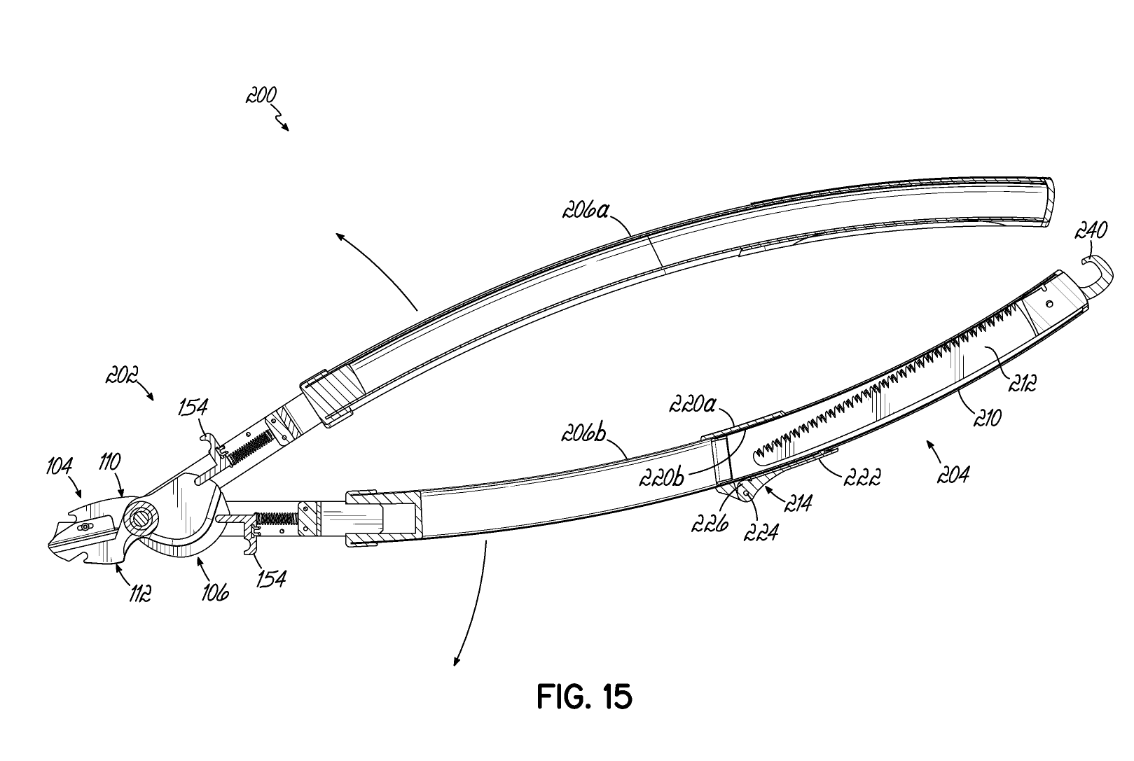

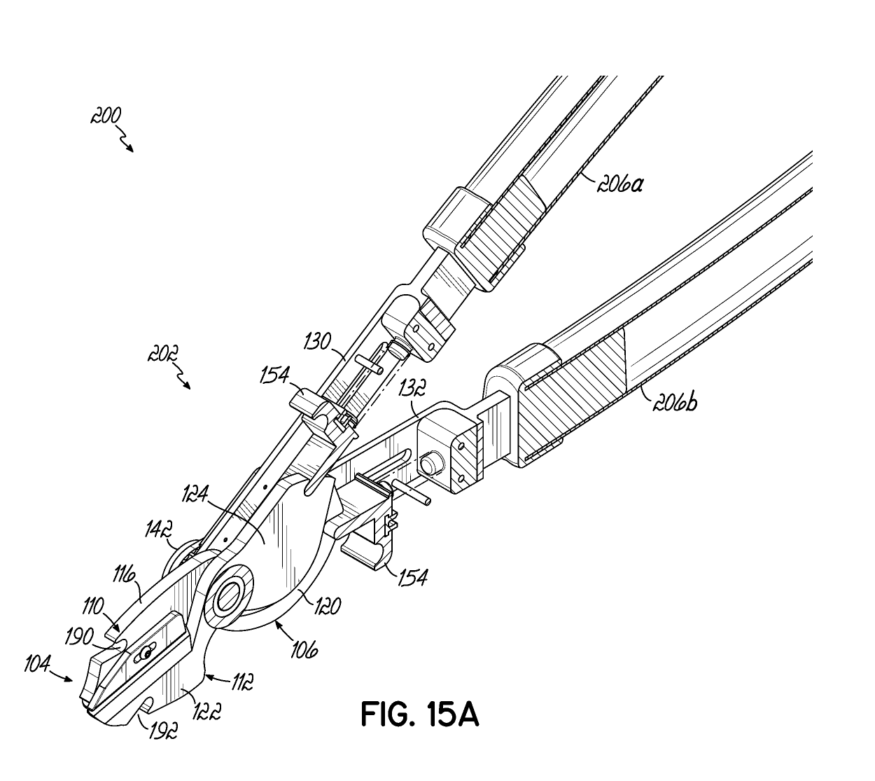

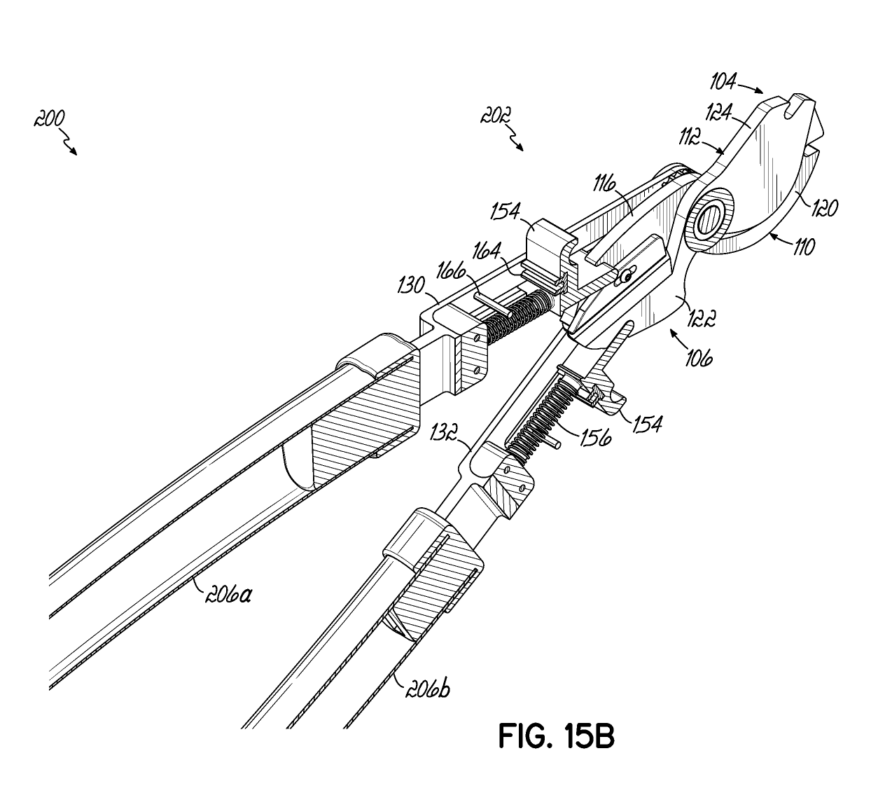

Referring to FIG. 14, a tool 200 incorporates a cutting mechanism. In the embodiment illustrated in FIG. 14, the cutting mechanism 202 is similar to that discussed herein with respect to FIGS. 7-13, for example. The handles 206a, 206b are used in a traditional sense for cutting. The tool 200 also incorporates an integral pruning saw assembly and feature as illustrated at 204 within at least one of the handles 206a,206b of the tool 200. In the illustrated embodiment, the pruning saw assembly 204 is incorporated into handle 206b. Referring to FIG. 15, the pruning saw assembly 204 incorporates a handle 210 and an integral saw blade 212. The handle 210 portion acts as a portion of the handle 206b when the tool 200 is used as a cutter mechanism. That is, the handle 210 portion remains integral with the larger handle 206b of the tool until the pruning saw assembly is deployed. As illustrated in FIG. 15, movement of the handles in the direction of the arrows allows cutting and pruning as desired. Handle portion 210 is held integral with the handle 206b by a latch mechanism 214. When the latch mechanism is latched, the pruning saw assembly 204 remains with the handle. Selectively, the latch mechanism 214 may be unlatched to release the pruning saw assembly 204.

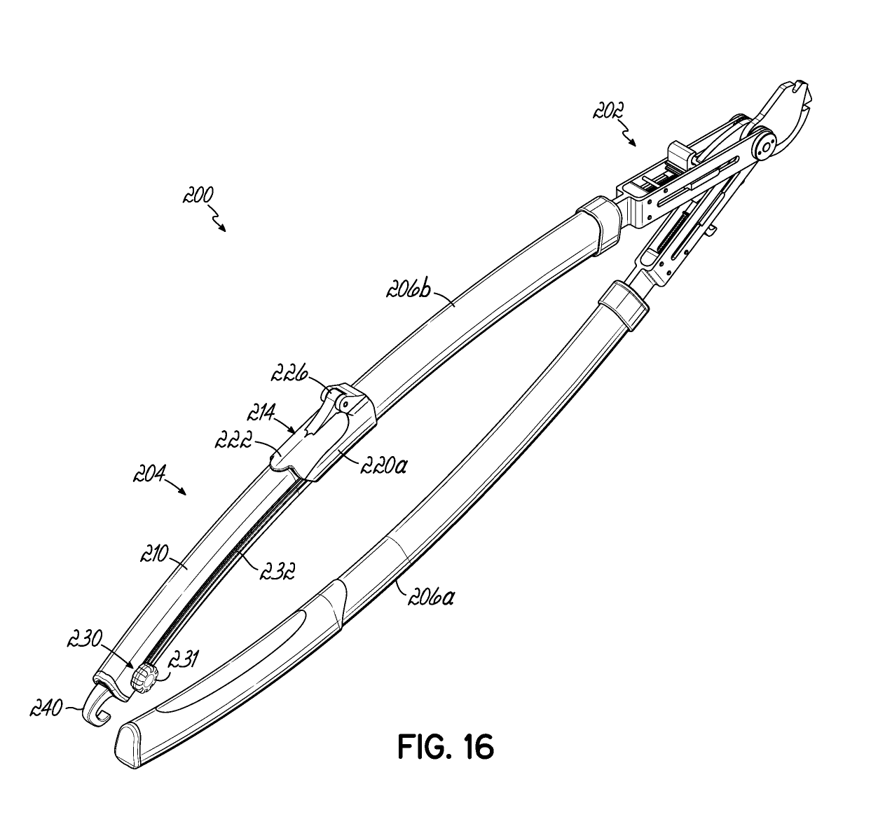

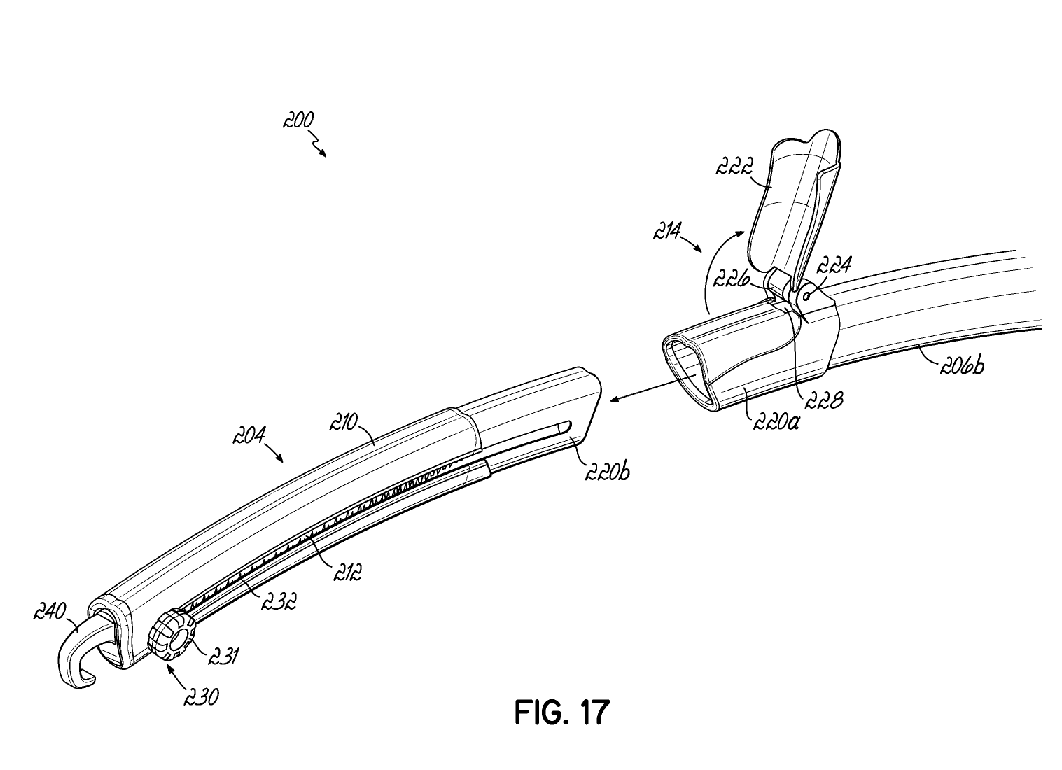

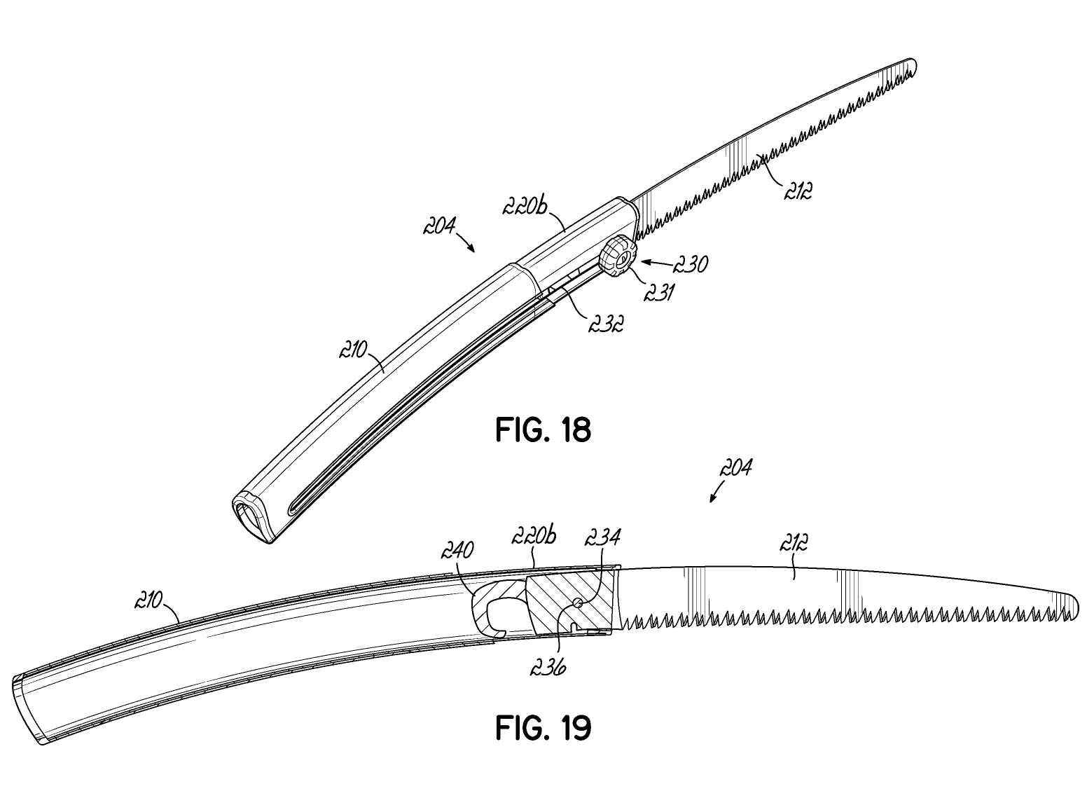

The latch mechanism 214 as illustrated in FIG. 16 is located along the handle 206b to provide a saw handle with a sufficient length for the length of the blade 212 stored within the handle portion 210. As illustrated in FIGS. 16 and 17 the latch mechanism 214 includes a telescoping segment 220a that matches with the telescoping segment 220b on the handle 210 of the pruning saw assembly 204. A hinged latch 222 hinges about axis 224 and includes a cam 226 that bears against telescoping section 220b through opening 228 when the portions 220a and 220b are telescoped together as illustrated in FIGS. 15 and 16. By pivoting the latch 222 as shown by the arrow in FIG. 17 away from telescoping section 220a, the cam 226 is moved away from engagement with telescoping section 220b and the handle 210 may be slid away from handle 206b as shown in FIG. 17. In that way, the pruning saw assembly is separated and ready for use. Pruning saw assembly 204 includes saw blade 212 that has a stored position where it is stored inside the handle portion 210 and an extended deployed position. The blade may be extended from portion 210 and is shown extended in FIGS. 18 and 19. The assembly 204 also includes a screw tensioner 230 that slides in a track 232 formed within the handle 210 portion. Referring to FIG. 19, the tensioner 230 includes a knob 231 and threaded shaft 234 that extends through an appropriately formed opening 236 within one end of the blade 212 that may be rotated to loosen or tighten the end of the blade 212 in relation to the handle portion. To deploy the saw, the tensioner knob 231 and shaft are rotated until tension on the blade it is loosened. Once loose, the tensioner may be slid along the track to push the blade along the length of the handle portion 210 to the extended, deployed position as illustrated in FIG. 18. A portion of the track 232 extends along the telescoping portion 220b. The tensioner is moved along the full length of the track 232 to deploy blade 212 as shown. The tensioner mechanism 230 is then rotated to tighten the blade with the handle portion 210 and lock it into the position as shown in FIGS. 18 and 19. Then, the assembly may be used as a pruning saw as needed. To return the assembly 204 back to the tool 200, the process is reversed. The tensioner 230 is loosened to move again on track 232, blade 212 is withdrawn to the storage position, and the tensioner is again tightened. The telescoping portion 220b is then inserted into telescoping portion 220a as shown in FIG. 17 and the latch is rotated back so that the cam 226 acts on a surface of telescoping portion 220b to hold the handle 210 together with the larger overall handle 206b. When the tool 200 is in the cutter formation as illustrated in FIGS. 15 and 16, assembly 204 includes a hook 240 at the base end of the saw blade and the assembly that may be used for hanging the tool 200.

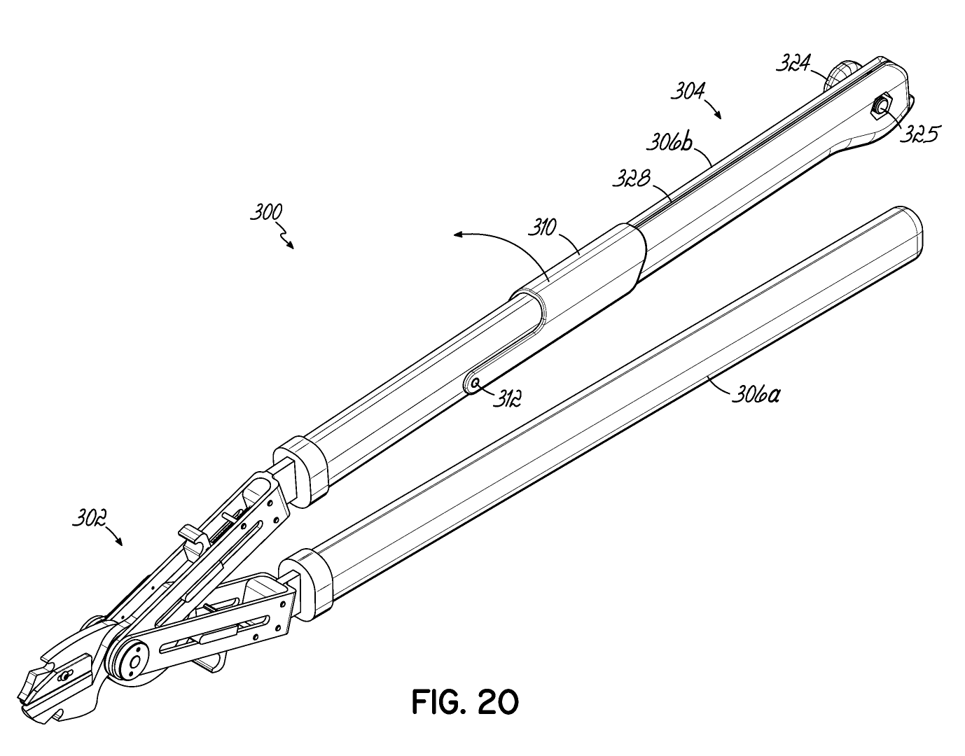

FIGS. 20-25 illustrate another alternative embodiment of the invention. Specifically, FIG. 20 illustrates a tool 300 that incorporates a cutter/pruner mechanism 302 in combination with a pruning saw assembly 304. As discussed with respect to the embodiment illustrated in FIG. 14, the cutter mechanism 302 may implement features of the invention as discussed with respect to FIGS. 8-13 or may incorporate some other cutter mechanism, such as a dedicated anvil type cutter or a dedicated bypass type cutter rather than the reconfigurable mechanism of the invention. As such, the features of the invention as set forth with respect to FIGS. 20-25 and the pruning saw assembly are not limited to a particular cutter mechanism 302 utilized with the tool 300.

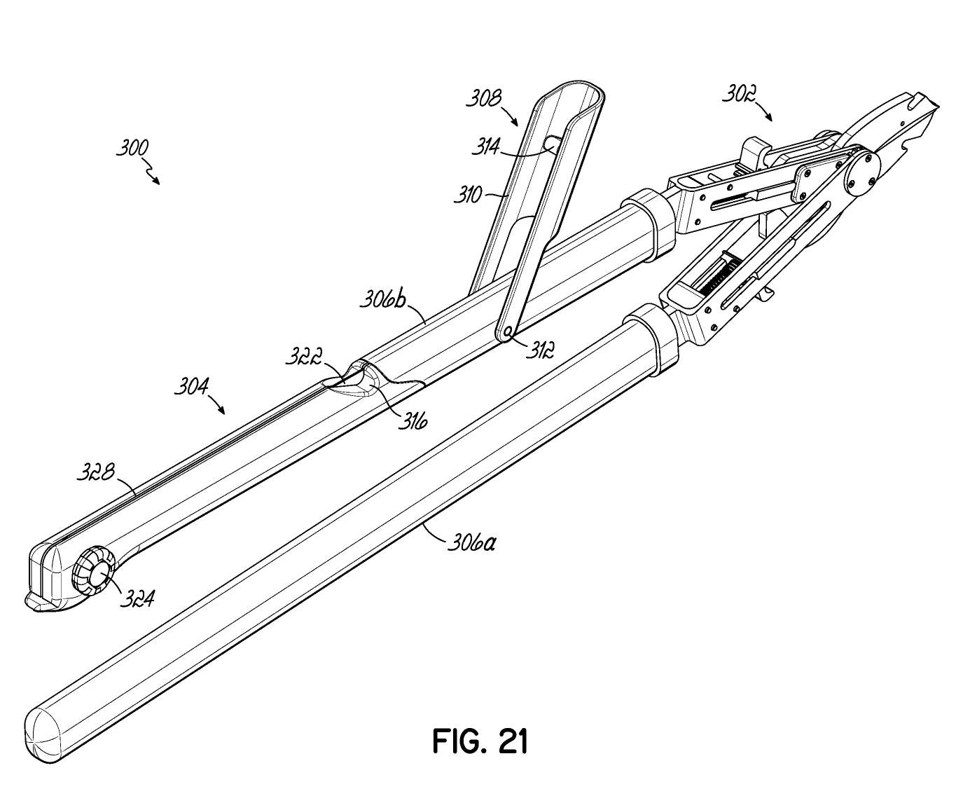

The pruning saw assembly 304 is incorporated into at least one of the handles 306a,306b of the tool 300. As illustrated in the Figures, the pruning saw assembly 304 is incorporated with handle 306b to form a portion of the handle. Turning to FIG. 21, the pruning saw assembly 304 incorporates a latch assembly that has a rotating latch element 310 that rotates about an axis 312 in the handle 306b. Latch element 310 includes a stop element 314 that fits into a notch 316. When the latch element 310 is rotated to a down position against handle 306b as shown in FIG. 20, latch assembly 308 holds the pruning saw assembly 304 with the rest of handle to form the elongated handle 306b. However, when the latch is rotated away from handle 306b as shown in FIG. 21, the pruning saw assembly may be deployed.

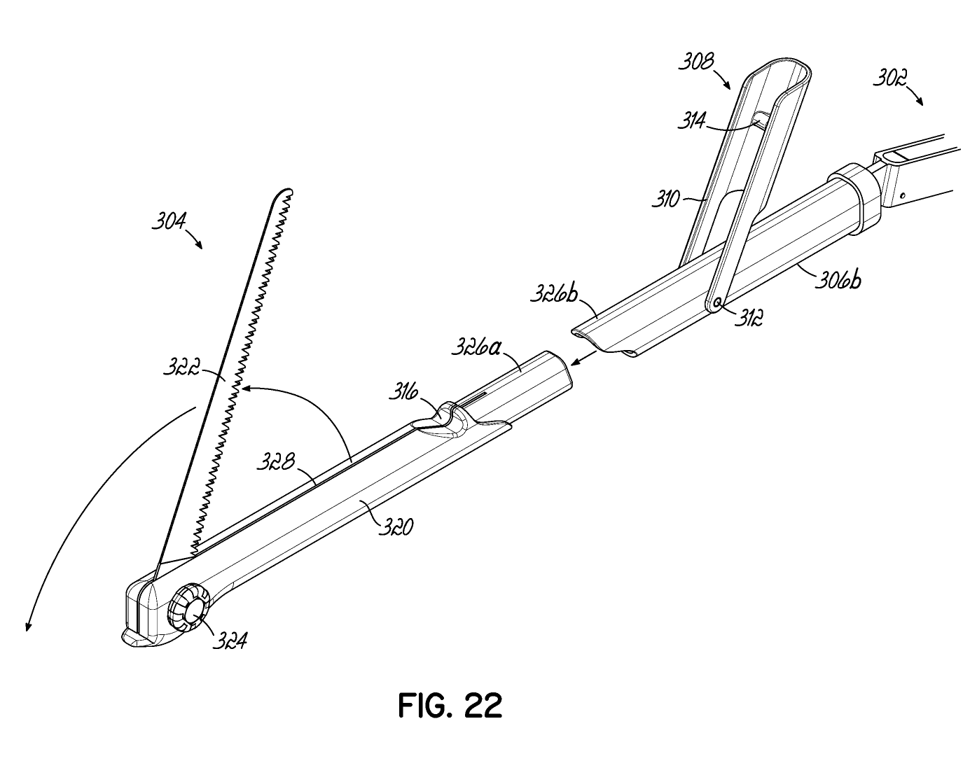

Specifically, referring to FIG. 22, the pruning saw assembly includes a handle portion 320, a blade 322, a tensioner mechanism 324, and a telescoping section 326a which acts with a cooperating telescoping section 326b on the handle 306b. As illustrated in FIG. 22, telescoping section 326a fits inside of telescoping section 326b. However, other configurations might be utilized for securing the saw assembly with the handle. Blade 322 is stored within the pruning saw assembly 304 within a slot 328 formed in handle portion 320. In the illustrated embodiment, the blade 322 extends through notch 316 as shown in FIG. 21. Accordingly, the stop element 314 might also be slotted so as not to interfere with blade 322 so that latch element 310 may be folded downwardly against handle 306b.

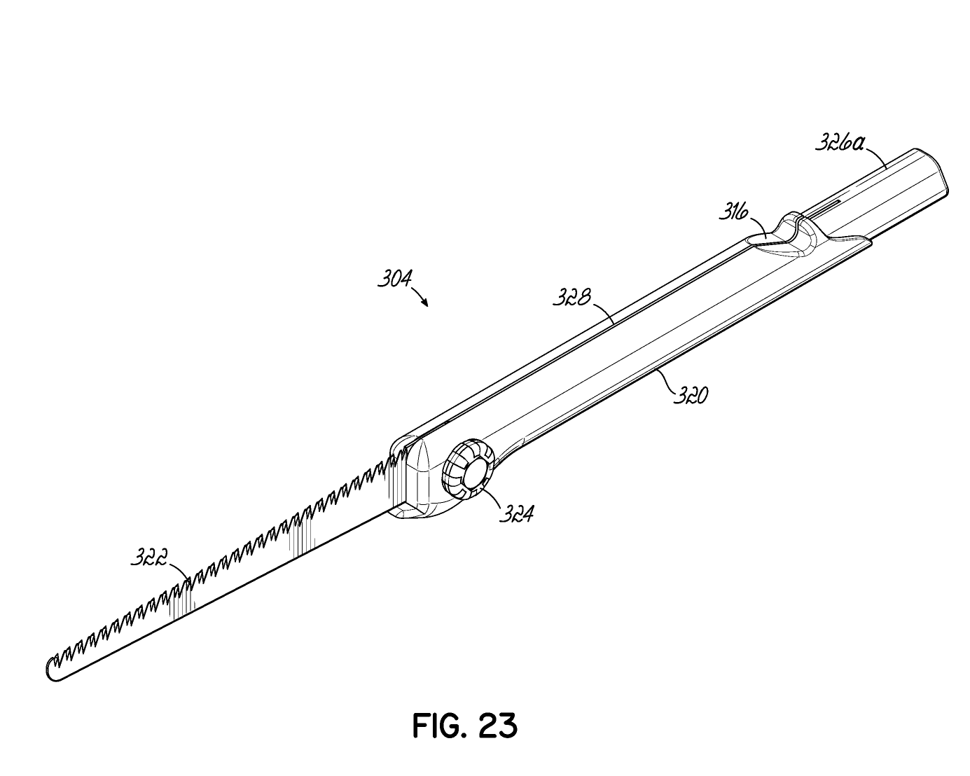

To deploy the saw, the latch element 310 is rotated away from handle 306B as shown in FIG. 21. Referring to FIG. 22, this also frees up the blade 322 that may be rotated out of slot 328 to a deployed position as shown by the arrows in FIG. 22. The tensioner mechanism 324 may be tightened when the blade is in the fully deployed position as illustrated in FIG. 23. In such an arrangement, the blade 322 will generally be in a linear alignment with the saw handle 320. Generally, the tensioner mechanism 324 as illustrated in FIG. 20 includes a knob 323 that is coupled with a threaded bolt 325 that may be coupled as well with a nut (not shown). Rotation of the knob tightens or loosens the tensioner mechanism for securing the blade as desired.

In accordance with one aspect of the invention, once the latch mechanism has been opened and the blade deployed, the pruning saw assembly 304 and handle portion 320 may be separated from the handle 306b and the rest of the tool 300 as shown in FIGS. 22 and 23. As such, the pruning saw assembly 304 may then be used as a separate pruning saw wherein a user simply grips the handle portion 320 and uses the saw as shown in FIG. 23.

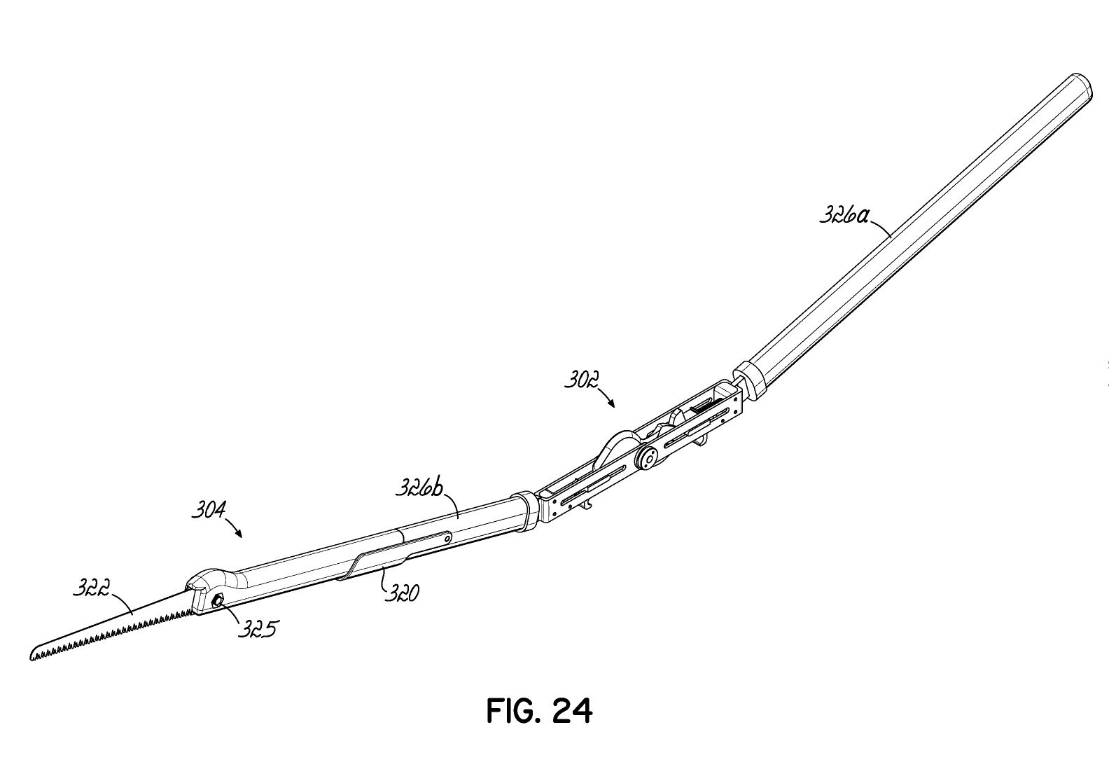

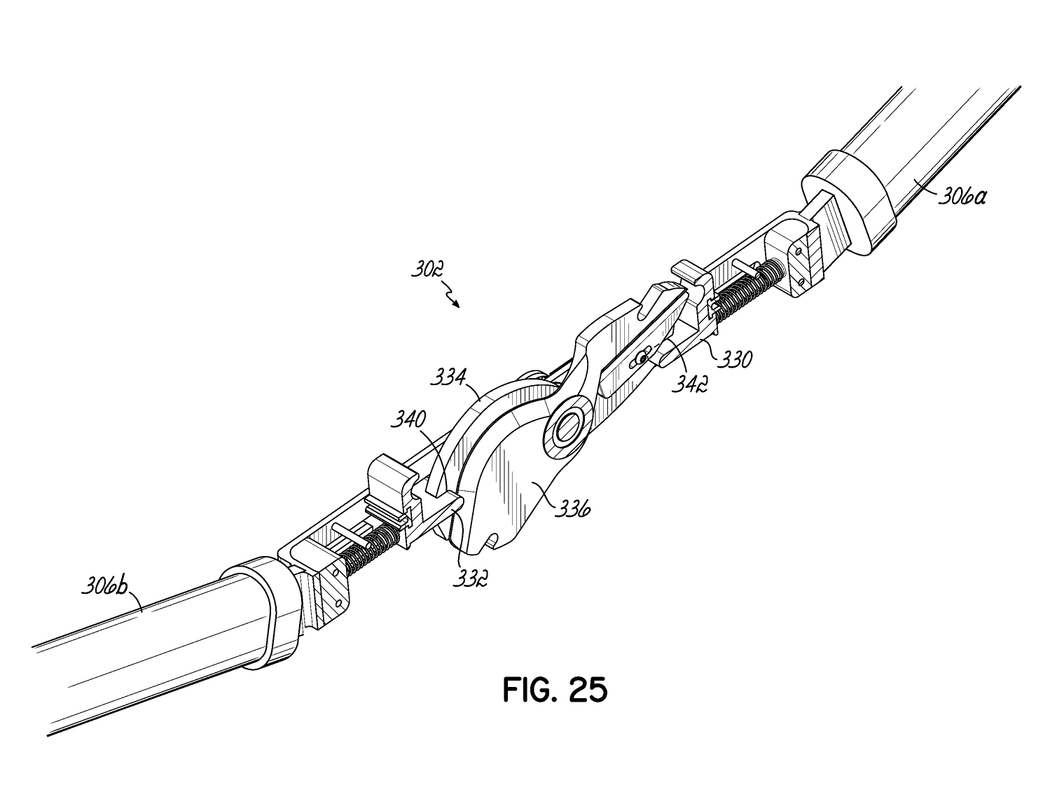

In an alternative embodiment of the invention, once the blade is deployed 322 and tightened into the extended position with the tensioner mechanism 324, the assembly may be reinserted with handle 306b and then relatched such that the latch 310 holds the handle 320 with the larger overall handle 306b and the tool 300. In that way, the pruning saw assembly 304 may be utilized as an extended pole saw with the tool as illustrated in FIGS. 24 and 25. More specifically, the handles 306b and 306b may be utilized along with the cutter mechanism 302 for forming a pole saw as illustrated in FIGS. 24-25. The tool shown in FIG. 24 is shown with a slight angle in the handles once they are extended into the pole saw embodiment. As may be appreciated, the handles could be arranged with the cutter mechanism such that the pole is a straight pole rather than angled.

The cutter mechanism 302 used with tool 300 may resemble the mechanism as illustrated in FIGS. 7-13 and may be used to implement one way or extending the handles into the pole shape Other mechanisms might be used to secure the two handles together into a pole form, but in the illustrated embodiment, the cutter mechanism and features thereof might be used to provide the extension. The blade elements in such a mechanism would have appropriate notches for allowing the reconfiguration of the tool between different types of cutter mechanisms. To form the extended pole saw version as illustrated in FIG. 24-25, at least one of the latch mechanisms 332 may be unlatched to disengage from a notch of a respective blade element 334,336. The handle 306a or 306b associated with the unlatched mechanism may then be rotated about the pruner mechanism 302 (or vice versa) in a fashion similar to the way that tool might be configured between different cutter mechanisms. Then the respective unlatched or disengaged latch 330,332 may engage into a respective notch 340 or 342 in the same blade element 334,336 as shown in FIG. 25.

FIG. 25 is a cutaway version of one suitable pruning mechanism 302 for providing such an extended pole saw embodiment as illustrated in FIG. 24. In typical use, one of the handles is engaged or latched with a respective one of the blade elements 334, 336 and acts on the respective blade element to move them toward and away from each other for the cutting function. Since each of the blade elements 334,336 are rigid elements, then coupling both handles 306a, 306b with a single element, the tool may turn into an extended pole structure. Accordingly, by incorporating the latch mechanisms 330,332 into notches 340,342 associated with just a single blade element, either 334 or 336, the handles 306a and 306b are rigidly coupled together to form the elongated pole structure as illustrated in FIG. 24 for the purposes of having an extended pruning saw or pole saw for implementing the pruning saw assembly 304. In that way, a user has an extended reach for the purposes of any pruning or trimming tasks. While the embodiment illustrated in FIG. 25 shows the latch mechanisms 330,332 incorporated into the blade element 334, those latch elements or others might also be incorporated into the respective notches formed in blade element 336 for the purposes of providing the pole saw embodiment illustrated in FIG. 24. The notches might be arranged on the blade elements to make a more straight pole version with the handles as noted. Furthermore, the blade 322 could be arranged such that the cutting teeth are on the opposing edge and opposite to what is shown in FIG. 24. Accordingly, the present invention as illustrated in FIGS. 20-25 illustrates an embodiment wherein the pruning saw assembly might be used separately (FIG. 23) or in an extended pole saw arrangement (FIG. 24).

What is claimed is:

1. A landscaping tool comprising:
a pair of blade elements configured to rotate independently about an axis;
each blade element having a different blade section formed at opposing ends of the respective blade element, the blade sections at one end of the blade elements cooperating to form one type of cutter mechanism at the one end and the blade sections at the other opposing end of the blade elements cooperating to form a different type of cutter mechanism at the opposing end;
a pair of handles configured to rotate about the axis and to be moved toward each other to act on the blade elements, each handle configured to act upon a different blade element to rotate the cooperating blade sections in opposite directions and toward each other to provide a cutting function;
the handles rotatable about the axis to selectively act on one end of the blade elements and provide the one type of cutter mechanism or act on the opposing end of the blade elements to provide the different type of cutter mechanism;
the blade sections of at least one of the cutter mechanisms including a notch formed therein, the notch engaging with a respective handle to reduce the distance that the handles have to move toward each other to provide the desired cutting function.
